(19) United States
(12) Patent Application Publication
(10) Pub. No.: US 2011/0029347 A1
(43) Pub. Date: Feb. 3, 2011

(54) METHOD FOR WIRELESS NETWORK VIRTUALIZATION THROUGH SEQUENTIAL AUCTIONS AND CONJECTURAL PRICING

(76) Inventors: Ulas C. Kozat, Santa Clara, CA (US); Fangwen Fu, San Diego, CA (US)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 12/795,574

(22) Filed: Jun. 7, 2010

Related U.S. Application Data
(60) Provisional application No. 61/230,223, filed on Jul. 31, 2009.

(51) Int. Cl. G06Q 10/00; H04W 74/04; G06Q 30/00

(52) U.S. Cl. 705/8; 455/509

(57) ABSTRACT

A method and apparatus is disclosed herein for wireless network virtualization through sequential auctions and conjectural pricing. In one embodiment, the apparatus comprises a plurality of service providers operable to bid on network resources on behalf of a plurality of individual receivers and a wireless network operator, communicably coupled to the plurality of service providers, to perform resource allocation using an auction to allocate network resources to the plurality of service providers based on instantaneous channel conditions and traffic information of each of the individual receivers and to schedule transmissions in time and space to the individual receivers.

### PRIORITY

The present patent application claims priority to and incorporates by reference the corresponding provisional patent application Ser. No. 61/230,223, titled, “A Method for Wireless Network Virtualization Through Sequential Auctions and Conjectural Pricing,” filed on Jul. 31, 2009.

### FIELD OF THE INVENTION

The present invention relates to the field of wireless broadband communication, cellular systems, and network virtualization; more particularly, the present invention relates to performing resource allocation using auctions based on bids from service providers based on conjectural pricing.

### BACKGROUND OF THE INVENTION

Wireless networks are experiencing a big challenge. On one hand, services and their objectives, constraints, as well as demands exhibit a high degree of heterogeneity and potentially a time-varying nature. On the other hand, channel conditions across the users can be quite different and time-varying as well. Traditional wireless network architectures that fix/limit the services or service classes and optimize the radio stacks accordingly might not be viable for future service innovation and growth. It is of paramount importance to lay out a flexible enough layering of wireless networks and develop the right interfacing between the application needs and the wireless resource allocation decisions.

In spite of the richness of virtualization technologies for the wired networks, wireless network virtualization is more slowly evolving. A few instances of wireless network virtualization either tries to statically orthogonalize the spectrum through using non-interfering channels and/or scheduling. In many cases, physical separation and reuse of the same channels are also proposed.

The use of auctions for dynamic wireless resources (e.g., spectrum, transmission time) have been investigated. However, these approaches do not consider the heterogeneous services and the dynamics in the traffic characteristics, especially in a virtualized wireless network set up.

### SUMMARY OF THE INVENTION

A method and apparatus is disclosed herein for wireless network virtualization through sequential auctions and conjectural pricing. In one embodiment, the apparatus comprises a plurality of service providers operable to bid on network resources on behalf of a plurality of individual receivers and a wireless network operator, communicably coupled to the plurality of service providers, to perform resource allocation using an auction to allocate network resources to the plurality of service providers based on instantaneous channel conditions and traffic information of each of the individual receivers and to schedule transmissions in time and space to the individual receivers.

### BRIEF DESCRIPTION OF THE DRAWINGS

The present invention will be understood more fully from the detailed description given below and from the accompanying drawings of various embodiments of the invention, which, however, should not be taken to limit the invention to the specific embodiments, but are for explanation and understanding only.

FIG. 1 illustrates wireless network virtualization including interfaces between service providers (SPs), network operator (NO), and end users (e.g., receivers).

FIG. 2 is a block diagram illustrating one embodiment of service providers and a network operator.

FIG. 3 illustrates a specific example of the information exchange over the interfaces between different agents in the virtualized architecture.

FIG. 4 illustrates depiction of how different SPs utilities and decisions are entangled together.

FIG. 5 illustrates individual SPs optimizations are decoupled via the conjectural price computed by a NO for future resource congestion.

FIG. 6 is a block diagram of a computer system.

### DETAILED DESCRIPTION OF THE PRESENT INVENTION

Embodiments of the present invention accomplish wireless network virtualization by separating the wireless network operator from the service providers, dividing the responsibilities with a new layering perspective, and allowing service providers to dynamically bid for wireless resources on behalf of their users through sequential auctions.

The network virtualization disclosed herein supports multiple parallel networks over the same physical transport fabric. Virtualization can be logical as in the case of Virtual Private Networks (VPN), supporting multiple routing tables for each network instance, providing distinct MPLS interfaces, providing cycles from the same central processing unit (CPU) or it can be physical such as supporting multiple physically separate resources (including a network interface card, memory, CPU cores, circuits) or both.

Embodiments of the invention include a wireless network virtualization method that separates the network operator (NO) from the service providers (SP) as follows. A single NO controls the wireless resources (i.e., spectrum and power) and makes the layer 1/layer 2 decisions such as which receiver/user should receive in what time slot, sub-carriers, spreading codes, which channel coding/modulation should be used in each wireless resource blocks that span a number of time slots, subcarriers, antennas, and/or spreading codes, etc. The NO has the control over the actual pricing of the resources. For purposes herein, the pricing can be in real monetary terms or it can be a monitoring parameter to measure the congestion induced to the network by each SP which can be used to regulate the traffic, introducing penalties, or revising the service level agreements after a period. Multiple SPs run over the NO's network and they interact with the network operator through bidding for rate allocation for each of their users. SPs do not see the actual channels allocated to their own users nor the channel state information of the users. They can only monitor the rates allocated by the NO to their individual users and know about the pricing of the resources which in turn depends on the bids of the other SPs. In determining their bids, each SP can use different objectives and constraints. In one embodiment, the NO is completely oblivious to the quality of service (QoS) targets of individual services and/or users. It is solely the SP's responsibility to acquire the correct rate guarantees through the right bidding strategy so that the service QoS objectives and constraints are met.

In one embodiment, to assist SP's in their current bidding decisions, the NO also provides a conjectural price to all SPs for future network usage based on the history and/or statistics of demand from all the SP's. The interfaces between the network operator, service providers, and users as well as the control action taken by each of these entities are all disclosed.

In one embodiment, within the disclosed framework, the interactions among SPs and NO are modeled as a stochastic game, each stage of which is played by SPs (on behalf of the end users) and is regulated by the NO through the Vickrey-Clarke-Groves (VCG) mechanism. Due to the strong coupling between the future decisions of SPs and lack of global information at each SP, the stochastic game is notoriously hard. Instead, conjectural prices are used to represent the future congestion levels the end users potentially will experience, via which the future interactions between SPs are decoupled. Then, the policy to play the dynamic rate allocation game becomes selecting the conjectural prices and announcing a strategic value function (e.g., the preference on the rate) at each time. At least one Nash equilibrium exists in the conjectural prices and, given the conjectural prices, the SPs have to truthfully reveal their own value function. This Nash equilibrium results in efficient rate allocation in the virtualized wireless network. In other words, there are enough incentives for NO to advertise such a conjectural price and SPs to follow this advice.

In the following description, numerous details are set forth to provide a more thorough explanation of the present invention. It will be apparent, however, to one skilled in the art, that the present invention may be practiced without these specific details. In other instances, well-known structures and devices are shown in block diagram form, rather than in detail, in order to avoid obscuring the present invention.

Some portions of the detailed descriptions which follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention also relates to apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear from the description below. In addition, the present invention is not described with reference to any particular programming language. It will be appreciated that a variety of programming languages may be used to implement the teachings of the invention as described herein.

A machine-readable medium includes any mechanism for storing or transmitting information in a form readable by a machine (e.g., a computer). For example, a machine-readable medium includes read only memory (“ROM”); random access memory (“RAM”); magnetic disk storage media; optical storage media; flash memory devices; etc.

### Network Overview

### Wireless Network Virtualization

A broadband wireless network (e.g., cellular networks) that supports multiple heterogeneous services with different QoS requirements (e.g., delay, throughput, jitter, etc.) is described herein. In one embodiment, each service is managed autonomously and end users can subscribe to one or more services separately. The available network resources (e.g., spectrum) are dynamically managed by a single network operator (NO) through user scheduling, (sub-) channel allocations, rate and power control. To efficiently utilize the network resources, dynamic resource allocation is performed by the NO based on the instantaneous channel conditions and traffic information of each end user. The dynamic resource allocation introduces complicated coupling between the network infrastructure and supported services, resulting in the complex cross-layer optimization with significant signaling overhead, which prohibits its implementation in the current layered network architecture.

In one embodiment, the wireless network is virtualized in order to decouple services from the network infrastructure such that multiple heterogeneous services can be easily supported over the shared wireless network. Unlike the traditional layering where packets belong to different QoS classes and served accordingly, in this network framework, the NO becomes agnostic to the specifics of QoS objectives and constraints of individual services. Instead, service providers bid on behalf of their users for the network resources to be allocated in the next scheduling interval. Given the achievable rate region, the NO specifies its user scheduling and spectrum allocation policy that determines the rates received by each user (hence each service) in the next scheduling interval. The NO manages all the physical layer and MAC layer stacks and therefore is responsible for mapping the individual user payloads on to the radio carriers through channel coding, modulation, and waveform generation. All of these lower layer complexities are hidden from the services and their providers, i.e., different services compete for the rate without having to know the wireless infrastructure details.

In the virtualization framework disclosed herein, in one embodiment, end users are classified into several groups based on the subscribed services. These services are often offered by different service providers and have incentives (i.e. self-interested) to compete for the limited wireless network resources with other services. The user payloads above the radio link layer are managed and queued by the corresponding service provider (SP). Each SP aims at acquiring a proper rate allocation for its users by exchanging the traffic information with the NO. The traffic information is abstracted via a rate-utility function and the NO has no knowledge of how rate-utility function is generated or updated. Since SPs are self-interested, the traffic information exchange may be strategic as it will be discussed in more detail below. To perform resource allocation, the NO further requires the channel information through the exchange with the individual end users. Since the network infrastructure is pre-specified, the channel information exchange is non-strategic.

### B. Channel Model: Network Operator's View

In one embodiment, the NO views the channel as a time-slotted system, in which the NO makes scheduling decisions every W seconds (referred to as time slot or scheduling interval interchangeably hereon). The network operator has N orthogonal subchannels each of which is indexed by jε{1, . . . , N}.

In this network, there are in total K end users each of which is indexed by kε{1, . . . , K}. During the transmission, it is assumed that the end users experience a block-fading channel. At time slot t, end user k experiences the channel gain hₖⱼ^{t} at subchannel j and the channel gain is constant within the time slot. The channel gain profile of user k at all the subchannels is denoted by hₖ^{t}=[hₖ₁^{t}, . . . , h_{kN}^{t}]^{T} where x^{T} represents the transpose of a vector or matrix x. Herein, it is assumed that the channel gain hₖⱼ^{t} its i.i.d. across time for user k at subchannel j with the probability density function (pdf) of fₖⱼ(h).

Given the wireless network infrastructure, it is assumed that the channel gain profile of user k is truthfully known to both user k and the NO. Note that the channel gain of user k may not be observed by other end users. For simplicity, it is assumed that any fraction of scheduling interval can be assigned to individual receivers. Accordingly, within time slot t, the NO performs user scheduling and spectrum allocation by specifying the fraction of time wₖⱼ^{t} for user k at subchannel j. In one embodiment, wₖⱼ^{t} continuously takes values in [0, W], which approximates the discrete time allocation in the real system. As another simplifying assumption, it is assumed that the normalized power allocation ρₖⱼ is constant for user k at subchannel j during the whole transmission period. However, the disclosed framework can be easily extended to the scenarios that the transmission power can be dynamically adapted. Given the time allocation at each subchannel, the total transmission rate (e.g., information theoretic rate) for user k at time slot t is computed as follows.

$${r}_{k}^{t} = {\sum }_{j = 1}^{N} \frac{1}{2} B log ( 1 + {ρ}_{kj} {h}_{kj}^{t} ) {w}_{kj}^{t} \qquad ( 1 )$$

where B the bandwidth of each subchannel. Since the resource allocation is performed by the NO, the wireless network can be virtualized and the wireless network resource abstracted as the rate region denoted by [symbol] . The rate region is computed as the set of rates that can be achieved by any spectrum allocation. Specifically, the rate region is given by:

$${ℛ}^{t} = \{ {r}^{t} ∈ {ℝ}_{+}^{K} \vert ∃ {w}_{kj}^{t} \geq 0 , ∀ k , {jr}_{k}^{t} = {\sum }_{j = 1}^{N} \frac{B log ( 1 + {ρ}_{kj} {h}_{kj}^{t} ) {w}_{kj}^{t}}{2} , {\sum }_{k = 1}^{K} {w}_{kj}^{t} \leq W , ∀ j \} \qquad ( 2 )$$

From Eq. (2), the rate region [symbol] is determined by the channel condition profile H^{t}=[h₁^{t}, . . . , h_{M}^{t}] which is known by the NO. Hence, the wireless network at each time slot can be represented by [symbol] , [symbol] (H^{t}). [symbol] is a convex region. Given the rate region [symbol] (H^{t}), the resource competition between SPs becomes the rate allocation with the constraint of rate profile being in the feasible region. In the following description, the wireless network at each time slot t is represented synonymously with state s^{t}. This virtualization separates the complicated spectrum sharing (e.g., user scheduling and spectrum allocation, etc.) from the services in the upper layer. Below, one embodiment of how the virtualized network resource (i.e. feasible rate region) should be allocated to the self-interested SPs is disclosed.

### Interface Between the NO and SPs

Depending on the services that they subscribe, the end users are divided into M groups each of which corresponds to one type of service provided by the service provider (SP) iε{1, . . . , M}. The set of users subscribed to service i is denoted by Kᵢ. Without any loss of generality, the focus is on the case where each wireless receiver is subscribed to only one service in the network. Hence, K=Σᵢ₌₁^{M}| [symbol] | where | [symbol] | is the cardinality of the set [symbol] Also assume that each end user at time slot t=1, . . . , is able to be characterized by a state gₖ^{t} representing the traffic state determined by the application user k runs. Given the rate rₖ^{t}, user k receives the immediate utility uₖ (gₖ^{t},rₖ^{t}) at state gₖ^{t}, it is assumed that the immediate utility uₖ(gₖ^{t},rₖ^{t}) is a concave, increasing and differential function of the allocated rate rₖ^{t}. In one embodiment, the long-term average utility user k receives is computed as

$${\overline{u}}_{k} = {lim}_{T -> ∞} \frac{1}{T} {\sum }_{t = 1}^{T} {u}_{k}^{t} \qquad ( 3 )$$

For example, if the immediate utility of user k is the allocated rate rₖ^{t}, the average utility is the average rate that user k receives. If the immediate utility is defined as uₖ(gₖ^{t},rₖ^{t})=gₖ^{t} where gₖ^{t} is defined as the queuing length at time slot t, the average utility becomes the average queue length which is proportional to the average delay experienced by user k. If the immediate utility is defined as the video distortion reduction of the transmitted video packets, the average utility is the average video quality user k obtains.

Given the transmission rate rₖ^{t}, the transition of the traffic state gₖ^{t} for each user k is denoted by gₖ^{t+1}=Gₖ gₖ^{t}, rₖ^{t}, aₖ^{t}) where aₖ^{t} is the arriving data at time slot t. For example, if gₖ^{t} is the length of one queue in user k, the traffic state transition becomes gₖ^{t+1}=max {gₖ^{t}−rₖ^{t}}+aₖ^{t}. For simplicity, it is assumed that aₖ is an i.i.d. random variable.

The role of SP i is to dynamically ask for the network resources (i.e., indirectly competing for the network resource with other SPs) for each of its subscribed users. The satisfaction function of SP i is denoted by Fᵢ(ūᵢ) where ūᵢ={ūₖ}_{kεK}_{ᵢ}. The satisfaction function Fᵢ(ūᵢ) can also be interpreted as the willingness-to-pay (WTP) function of SP i which is determined by the service level provided to the end users in group i. Considering the case where the satisfaction functions of SPs are linear, in one embodiment, the utility function Fᵢ(ūᵢ) for SP i has the following form

$${F}_{i} ( {u}_{i} ) = {\sum }_{k ∈ {κ}_{i}} {α}_{k} {\overline{u}}_{k} \qquad ( 4 )$$

where αₖεR₊ is the weight of the user k. Then, at time slot t, SP i has the utility

$${v}_{i}^{t} = {\sum }_{k ∈ {κ}_{i}} {α}_{k} {u}_{k}^{t} and {F}_{i} = {lim}_{T -> ∞} \frac{1}{T} {\sum }_{t = 1}^{T} {v}_{i}^{t} .$$

Due to the decentralized nature of the wireless network and self-interested service providers, a simple pricing mechanism named the Vickrey-Clarke-Groves (VCG) mechanism, which is well-known in the art (for example, see Jackson, “Mechanism Theory”, In The Encyclopedia of Life Support Systems, 2000) is used in the framework. In this pricing mechanism, the SPs bid for the limited resources (e.g., the subchannels and power) on behalf of the end users associated with them at each time slot. Since the NO knows the channel state instead of directly bidding for the subchannels and power, SP i only needs to bid on the allocated rates for its own end users (e.g., receivers).

At each time slot t, SP i has the value over the potential allocated rate rᵢ^{t}. This true value is denoted by θᵢ(gᵢ^{t},rᵢ^{t}) where

$${g}_{i}^{t} = [ {\{ {g}_{k}^{t} \}}_{k ∈ {𝒦}_{i}} ] .$$

Note that the value function θ(gᵢ^{t},rᵢ^{t}) may differ from the immediate utility function vᵢ^{t} which will be described below.

Since the SPs are self-interested, they have incentives to announce a value function \hat{θ}(rᵢ^{t}) different than θᵢ(gᵢ^{t},rᵢ^{t}). In the VCG mechanism, receiving the announced value function \hat{θ}(rᵢ^{t}), the NO performs the rate allocation within the feasible rate region [symbol] (H^{t}) as follows:

$${r}^{{t}_{,}^{*}} = arg {max}_{r ∈ ℛ ( {H}^{t} )} {\sum }_{i = 1}^{M} {\hat{θ}}_{i} ( {r}_{i}^{t} ) \qquad ( 5 )$$

Note that r without subscript is the rate allocation for all the end users, which is applied to other notation as well. Given the optimal rate allocation r^{t,*}, the NO further computes the payment for SP i as follows:

$${τ}_{i}^{t} = {\sum }_{{i}^{′} = 1 , {i}^{′} \neq i}^{M} {\hat{θ}}_{{i}^{′}} ( {r}_{{i}^{′}}^{{t}^{*} ,} ) - {\sum }_{{i}^{′} = 1 , {i}^{′} \neq i}^{M} {\hat{θ}}_{{i}^{′}} ( {r}_{{i}^{′} , - i}^{{t}^{*} ,} ) \qquad ( 6 )$$

where r_{i′,-i}^{t,*} is the optimal rate corresponding to the rate allocation rule in Eq. (5) when users kε [symbol] is are not included in the rate allocation. Notice that τᵢ^{t}<0 which signifies the fact that SP i pays the amount of |τₖ^{t}| of money to the NO. Properties of the VCG mechanism for one time-slot resource allocation are as follows:
Individual rationality: The payoff of each SP, θᵢ(gᵢ^{t},rᵢ^{t,*})+τᵢ^{t}, at any time slot t is not less than 0. In other words, participating the rate allocation game induced by the VCG mechanism at each time slot is better than not participating it and having a zero payoff
Incentive compatibility: No matter what value function (truthful or not) other SPs announce to the NO, the truthful value function θᵢ(gᵢ^{t},rᵢ^{t}) of SP i provides the best payoff. This implies that θᵢ(gᵢ^{t},rᵢ^{t}) is the optimal value function SP i should announce to the NO, i.e., SPs have the incentive to announce a value function \hat{θ}ᵢ(rᵢ^{t}) equal to their true value function θᵢ(gᵢ^{t},rᵢ^{t}).
Efficiency: When all SPs announce truthful value functions, the NO allocates the rate to maximize the sum of all the SPs' value function, which results in the efficient rate allocation.

The VCG mechanism is truth-revealing, incentive compatible, individual-rational and efficient only with respect to the value function θᵢ(gᵢ^{t},rᵢ^{t}) in one time slot. However, in the context described herein, the rate allocation is performed repeatedly with various channel conditions and end users' traffic states.

In one embodiment of the framework, the VCG mechanism is applied at each time slot in order to capture the dynamics in the channel gains and traffic characteristics. When the channel gains change rapidly, it may require high computation cost and large signaling overhead to perform the VCG mechanism. However, to reduce the complexity, the proposed virtualization framework can be easily extended to the case in which the resource allocation as shown in Eq. (5) is performed every time slot and the payment is computed in a larger period (multiple time slots). In this way, the signaling about the value functions is executed only every multiple time slot.

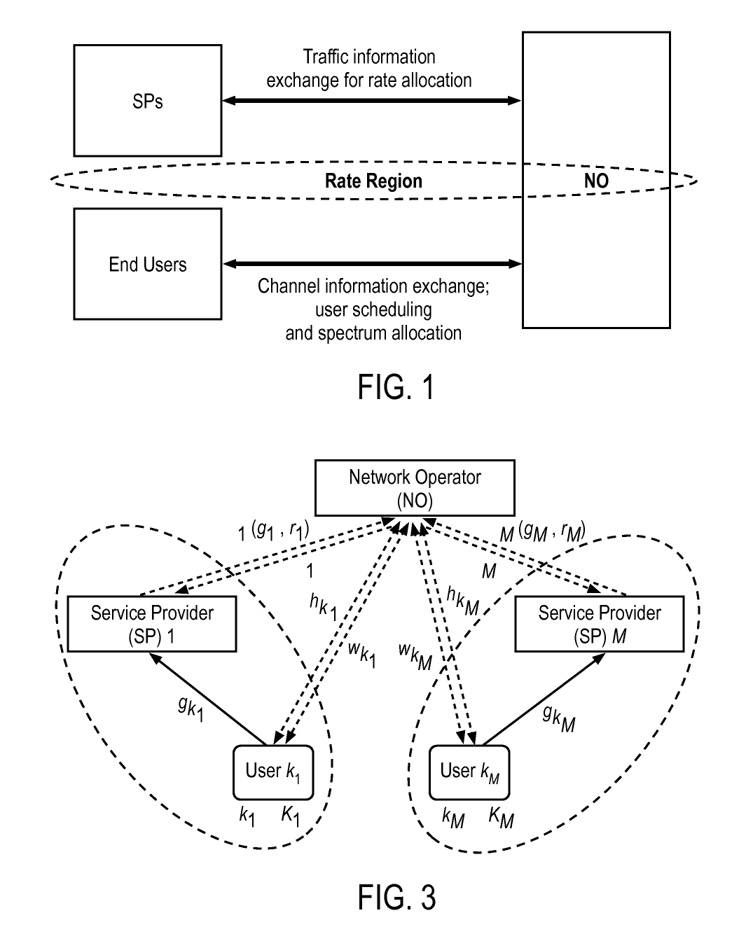

FIG. 1 shows one embodiment of the interfacing between the SPs and end users through the NO. Referring to FIG. 1, the NO has full control over the wireless resources including the spectrum, antennas, power, etc. The NO also monitors the channel qualities/states of individual receivers in the system. As such, the NO can compute the achievable rate region at a given block error rate. The NO makes the resource allocation decisions through scheduling transmissions in time and space to a plurality of individual receivers over the sub-bands of the spectrum and/or over the spreading codes it owns. The NO serves to one or more service providers and it has explicit knowledge of which users are managed by which SPs. The SPs request new resources in each scheduling interval in terms of number of bytes (e.g., payload) to be transmitted for each receiver based on the traffic information (e.g., backlog in a user queue) and utility of additional rate for each receiver. In this set up, the SPs through software programs that are collocated with a radio network controller node or a base station or any other device that controls the mapping of the payload onto wireless carriers can communicate with controller software run by the NO. SP software can be distributed over multiple network nodes and servers each performing joint and/or disjoint tasks. In one embodiment, an optimization agent runs closer to the controller software run by the NO. In one embodiment, this optimization agent computes the user utilities based on the current queue states of each user, the extra utility of additional payload served from the queue, the available budget the SP has, and the pricing enforced by the NO. In one embodiment, another part of the SP software is responsible for managing/updating the budget, the user authorization, authentication, accounting (AAA), and can be run deeper in the network architecture away from the points where wireless resources are managed. In one embodiment of the disclosed virtualization framework, there is a separation between the SPs in the wired domain and at least have the node that manages packet buffering above the wireless stack managed by the NO support virtual machines with dedicated hardware. In this way, the execution and data paths of different SPs are isolated from each other.

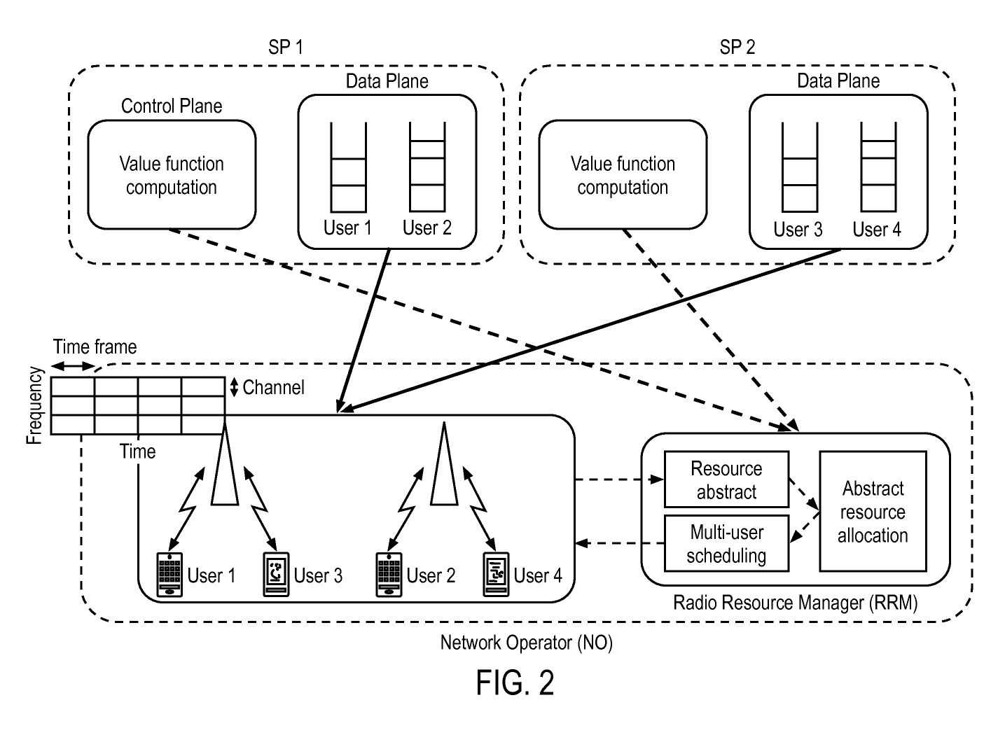

FIG. 2 is a block diagram illustrating one embodiment of service providers and a network operator. Referring to FIG. 2, each service provider comprises a control plane and a data plane. In one embodiment, the data plane includes a queue to store data for each user. The control plane observes and monitors traffic conditions and makes requests for resources based on the current state of the data plane. In one embodiment, the control plane also performs a value function computation as described herein.

The network operator allocates resources. In one embodiment, the network operator allocates buffer space for the data of individual users of the service providers and maps that data to individual channels. In one embodiment, this may be based on time and/or frequency. In one embodiment, the network operator includes a radio resource manager that performs abstract resource allocation in terms of channel resources based on a resource abstraction. In one embodiment, the abstract resource allocation is based on the value functions computed by the service providers. The radio resource manager also performs multi-user scheduling based on the abstract resource allocation.

### Stochastic Game Formulation

Although the VCG mechanism is efficient for the one time slot resource allocation and has dominant strategy (i.e. announcing the truthful value function) for each SP, to make it clear how the VCG mechanism can be adapted to the stochastic environment in which the available resources are repeatedly allocated to the wireless users with time-varying states in the following sections, the performance of the VCG mechanism in the stochastic environment is analyzed by formulating the rate allocation problem as a stochastic game, which is well-known in the art (for example, see Fink, “Equilibrium in a Stochastic n-person Game”, Journal of Science in Hiroshima University, Series A-I, 28:89-93, 1964). It is assumed that the NO performs the resource allocation based on the declared value functions and the underlying channel gains using the VCG mechanism. In other words, the VCG mechanism is fixed during each time slot. The objective of SP i is to maximize the payoff (i.e. the achieved utility minus the payment), which is given by

$${max}_{{θ}_{i}^{t}} \{ {F}_{i} ( {\overline{u}}_{i} ) + {\overline{τ}}_{i} \} \qquad ( 7 )$$

where τ̅ⁱ is the average payment to SPi which is computed as

$${\overline{τ}}_{i} = {lim}_{T -> ∞} \frac{1}{T} {\sum }_{t = 1}^{T} {τ}_{i}^{t}$$

and θᵢ^{t} is the revealed value function. In one embodiment, in order to maximize the payoff, SPi selects the value function θᵢ^{t}εΘᵢ which is viewed as the action to play the repeated rate allocation game. Here Θᵢ is the set of all possible value functions that SP i can take. The repeated rate allocation among SPs, can be formulated as a stochastic game as follows.

Definition 1: Stochastic Game for Repeated Resource Allocation

The stochastic game for the resource allocation is defined as follows.
There are M players each of which corresponds to one SP and one network coordinator which is the NO.
Each player has the state gᵢ^{t}, at time slot t.
Each player has the action θᵢ^{t}εΘᵢ which represents the value function on the allocated rate at time slot t.
The state transition of each player has the form of

$$pr ( {g}_{i}^{t + 1} \vert {g}_{i}^{t} , {r}_{i}^{t} ) {\prod }_{k ∈ {𝒦}_{i}} pr ( {g}_{k}^{t + 1} \vert {g}_{k}^{t} , {r}_{k}^{t} ) \qquad ( 8 )$$

Each player has the immediate payoff vᵢ^{t}=Σ_{kεK}_{ᵢ}αₖuₖ^{t}+τᵢ^{t}.
The objective of each player is the same as in Eq. (7).
The NO has the state H^{t}.
The state transition of the NO has the form of

$$pr ( {H}^{t + 1} \vert {H}^{t} ) = pr ( {H}^{t + 1} ) = {\prod }_{k = 1}^{K} {\prod }_{j = 1}^{N} {f}_{jk} ( {h}_{jk}^{t + 1} ) \qquad ( 9 )$$

The resource allocation at each slot is performed by the NO via the VCG mechanism: (r^{t},τ^{t})=VCG(θ^{t},H^{t}).
The state of the whole network is s^{t}={g^{t},H^{t}}.

In one embodiment, the resource allocation performed by the NO is based on the declared value function θ^{t} and the underlying channel conditions H^{t}. The output of the stage game induced by the VCG mechanism (e.g., one time slot resource allocation) is the allocated rate rᵢ^{t} and corresponding payment τᵢ^{t} for each SP i. The state transition of SP i is only determined by the allocated rate rᵢ^{t}. The channel state transition of the NO is independent of the resource allocation.

In this stochastic game, the policy πᵢ of SP i is a plan to play the game. Here πᵢ=(πᵢ¹, . . . , πᵢ^{t}, . . . ) is defined over the entire course of the game, where πᵢ^{t} is the decision rule at time slot t mapping the history of the game up to time t to the action of selecting the value function: πᵢ^{t}: [symbol] Θᵢ where each element in [symbol] is [symbol] =(s¹,θ¹,r¹,τ¹, . . . , s^{t-1},θ^{t-1},r^{t-1},τ^{t-1},s^{t}). πᵢ is called a stationary policy if πᵢ^{t}=πᵢ for all t and πᵢ is also called a Markovian policy if πᵢ( [symbol] )=πᵢ(s^{t}) where [symbol] ε [symbol] . Here, the focus is on the stationary and Markovian policies for all the SPs although the non-stationary and non-Markovian policies may provide rich equilibria for the stochastic game.

Instead of directly maximizing the long-term average payoff, i.e.,

$${F}_{i} ( {\overline{u}}_{i} ) + {\overline{τ}}_{i} = {lim}_{T -> ∞} \frac{1}{T} {\sum }_{t = 1}^{T} {v}_{i}^{t} ,$$

each SP is allowed to maximize the long-term discounted average payoff with discount factor βε[0,1)². The long-term discounted average utility for SP i is expressed as follows.

$${V}_{i}^{β} ( s , π ) = ( 1 - β ) {\sum }_{t = 1}^{∞} {β}^{t - 1} {v}_{i}^{t} \qquad ( 10 )$$

Note that the long-term discounted average payoff of SP i depends on the states and policies of all the SPs. The long-term undiscounted average payoff can be achieved when β approaches to 1. Hence, in the remainder of the discussion, the focus is on the policies that maximize the discounted average payoff instead of the undiscounted average payoff.

The best response of SP i to the policy π₋ᵢ of other SPs is represented by

$${π}_{i}^{*} ( π - i ) = arg { max}_{{π}_{i} ∈ {\prod }_{i}} {V}_{i}^{β} ( s , \{ {π}_{i} , {π}_{- i} \} ) , ∀ s \qquad ( 11 )$$

Based on the best response, the Nash equilibrium in the stochastic game is defined as follows.

Definition 2: Nash Equilibrium

The Nash equilibrium of the stochastic game is a policy π*=(π₁*, . . . , π_{M}*) such that for ∀s and ∀i, πᵢ* is the best response against the other SP policies π₋ᵢ*.

It can be shown that, for the discounted stochastic game, there always exists a stationary and Markovian policy that is Nash Equilibrium. However, it is notoriously hard to find the Nash equilibrium for the stochastic game. Actually, in order to operate at Nash Equilibrium, each SP needs to know the global state s, which is prohibited in one embodiment of the decentralized wireless network. In fact, during the resource allocation, each SP observes the partial history up to time t, [symbol] ={gᵢ¹,θᵢ¹,rᵢ¹,τᵢ¹, . . . , gᵢ^{t-1},θᵢ^{t-1},rᵢ^{t-1},τᵢ^{t-1},gᵢ^{t}} as shown in FIG. 2. In the next section, how the SPs play this stochastic rate allocation game with the partially observed information is discussed.

### Playing a Stochastic Game Via Conjectural Price

### Information Structure

FIG. 3 shows the information flow and relations between different entities. Referring to FIG. 3, each SP i has a number of users (denoted by set κᵢ) in a geographical area managed by the same radio resource controller of the NO (e.g., single cell associated with a base station or multiple cells). For each user k in κᵢ, SP i bids for the next scheduling interval by providing a value function \hat{θ}ᵢ(rᵢ), where rᵢ is the rate vector each entry corresponding to a unique user of SP i. This value function simply declares the importance/utility of a given rate allocation for the service provider. This declared value function can be different than the actual value function θᵢ(gᵢ^{t},rᵢ^{t}), where gᵢ^{t} is the traffic state (e.g., queue backlogs) vector for the users of SP i. The declared value function can be approximated as a piecewise linear function by sampling marginal utilities (i.e., individual user utility curves) at different rate values. Depending on the biddings from different SPs, the NO solves the following optimization problem:

$${r}^{t , *} = arg { max}_{r ∈ ℛ ( {H}^{t} )} {\sum }_{i = 1}^{M} {\hat{θ}}_{i} ( {r}_{i} )$$

Above M is the total number of service providers; R(H^{t}) is the achievable rate region given the channel conditions and power allocation in time slot t. In short, the NO solves a sum-utility maximization problem and the rate constraints of the wireless medium. In return of this allocation, the NO demands a payment from the SP i in the amount of:

$${τ}_{i}^{t} = {\sum }_{{i}^{′} = 1 , {i}^{′} \neq i}^{M} {\hat{θ}}_{{i}^{′}} ( {r}_{{i}^{′}}^{t , *} ) - {\sum }_{{i}^{′} = 1 , {i}^{′} \neq i}^{M} {\hat{θ}}_{{i}^{′}} ( {r}_{{i}^{′} , - i}^{t , *} )$$

Above r_{i′,-i}^{t,*} is the optimal resource allocation rule for SP i′ for the optimization problem, the NO solves in the absence of SP i. This pricing strategy guarantees that the SP's do not attempt to cheat in terms of their real utilities in the absence of budget constraints. Hence, the best strategy for SPs is to declare a true value function, i.e., \hat{θ}ᵢ(rᵢ)=θᵢ(gᵢ^{t},rᵢ^{t}). Note that the true utility function is not necessarily equal to the instantaneous utility if prediction about the future states by individual SPs is possible. In other words, at time t, SP i can under-value or over-value its current bid if future network states can be anticipated. For instance an SP which is delay-tolerant can back off when pricing by the NO is high if in the long run the SP can predict that prices will go down due to reduced utilization of the network outside peak hours.

In one embodiment, the SPs, on the other hand, optimize their bidding strategy to maximize their utility while keeping their payment low. Accordingly, the SP optimization problem is:

$${max}_{{θ}_{i}^{t}} \{ {F}_{i} ( {\overline{u}}_{i} ) + {\overline{τ}}_{i} \}$$

In one embodiment,

$${\overline{u}}_{k} = {lim}_{T -> ∞} \frac{1}{T} {\sum }_{t = 1}^{T} {u}_{k}^{t}$$

is the long term utility of user k, uₖ^{t} is the instantaneous utility of user k at scheduling interval/time slot t, and

$${\overline{τ}}_{k} = {lim}_{T -> ∞} \frac{1}{T} {\sum }_{t = 1}^{T} {τ}_{k}^{t}$$

is the long term payment to the NO. θᵢ^{t}=θᵢ(gᵢ^{t},rᵢ^{t}) is the value functions declared over the time by SP i and reflects the bidding strategy. The function Fᵢ(ūᵢ) is the overall utility objective of SP i and in one form it is a linear function of individual long term user utilities, i.e.,

$${F}_{i} ( {\overline{u}}_{i} ) = {\sum }_{j ∈ {K}_{i}} {α}_{j} {\overline{u}}_{j} .$$

As shown in FIG. 3, in this stochastic resource allocation game, the interaction between SPs are through the VCG mechanism performed by the NO at each time slot. At time slot t, the output of the VCG mechanism (also called the allocation at time slot t) is denoted by o^{t}=(o₁^{t}, . . . , o_{M}^{t}) where oᵢ^{t}=(rᵢ^{t},τᵢ^{t}).

Since the VCG mechanism is fixed during the whole course of the game, the allocation oᵢ^{t} is determined by the value function profile θ^{t}, the channel profile H^{t} of all the users. The allocation oᵢ^{t} is explicitly expressed as a function of the value function profile θ^{t} and the channel profile H^{t}, i.e. oᵢ^{t}(θ^{t},H^{t}). In this stochastic game, SP i submits the value function μt to compete for the network resource, which affects the game in two folds:
The announced value function θᵢ^{t} affects SP i's long term discounted average payoff through the allocation oᵢ^{t}. From FIG. 3, it is clear that the allocation oᵢ^{t} determines the immediate payoff vᵢ^{t}(gᵢ^{t},rᵢ^{t}) and the traffic state transition pr(gᵢ^{t+1}|gᵢ^{t},rᵢ^{t}).
The announced value function θᵢ^{t} also affects other SPs' long term discounted average payoff through the allocation o₋ᵢ^{t} in a similar way.
   Below, these impacts are characterized by introducing conjectural price for future resource allocation.

### Conjectural Price

Since the one time slot resource allocation game (i.e., stage game) is played repeatedly using the VCG mechanism with different states of the SPs at each time slot, the stochastic game can be split into two phases as shown in FIG. 3: current resource allocation (CurRA) game (i.e., one stage game) and future resource allocation (FutRA) game (which is also a stochastic game starting from different states of the SPs). As discussed below, the coupling between the CurRA game and FutRA game is that the output o^{t} of the CurRA game will affect the initial states of all SPs in the FutRA game. Assuming that in the FutRA game all SPs play the Nash Equilibrium policy π*, the corresponding discounted average utility is given by Vᵢ^{β}(s,π*), ∀i. Then, given the Nash equilibrium payoff Vᵢ^{β}(s,π), ∀i, the best-response of SP for the CurRA game with state profile s can be expressed as:

$${θ}_{i} ( s , {θ}_{- i} , {π}^{*} ) = arg {max}_{{θ}_{i} ∈ {Θ}_{i}} {\underbrace{( 1 - β ) ( {\sum }_{k ∈ {𝒦}_{i}} {α}_{k} {u}_{k} ( {g}_{k} , {r}_{k} ( {θ}_{i} , {θ}_{- i} , H ) ) + {τ}_{i} ( {θ}_{i} , {θ}_{- i} , H ) ) +}}_{current reward {v}_{i}^{t}} {\underbrace{β {\sum }_{{s}^{′}} \{ \{ \begin{matrix}{\prod }_{k ∈ {𝒦}_{i}} \{ pr ( {g}_{k}^{′} \vert {g}_{k} , {r}_{k} ( {θ}_{i} , {θ}_{- i} , H ) ) \} pr ( {H}^{′} ) \\ pr ( {g}_{- i}^{′} \vert {g}_{- i} , {r}_{- i} ( {θ}_{i} , {θ}_{- i} , H ) ) {V}_{i}^{β} ( {s}^{′} , {π}^{*} )\end{matrix} \} \}}}_{average future reward} \qquad ( 12 )$$

Note that s′=(gᵢ′,g₋ᵢ′,H′). Corresponding to the Nash equilibrium payoff Vᵢ^{β}(s, π*), ∀i, there is one Nash equilibrium π^{CurRA}(s) in the CurRA game. By the recursive nature of the stochastic game, the Nash equilibrium π^{CurRA}(s)=π* (s). In other words, the Nash equilibrium policy π* played in the FutRA game induces the Nash equilibrium π^{CurRA}(s) played in the CurRA game.

Now consider the case where instead of playing the Nash equilibrium policy π* in the FutRA game, the SPs play an arbitrary policy π which leads to the payoff Vᵢ^{β}(s, π), ∀i. From Eq. (12), the payoff Vᵢ^{β}(s,π), ∀i is known will induce a new CurRA game which is a one-stage game and has at least one (mixed) Nash equilibrium. The following lemma formally states the existence of the Nash equilibrium for the CurRA game and summarizes the discussion so far.

Lemma 3: Existence of Nash equilibrium in CurRA game

Any stationary policy π played by the SPs in the FutRA game can induce one Nash equilibrium policy π^{CurRA} (s,π) played in the CurRA game with the state s.

It is clear that π^{CurRA} (s, π*)=π*. The payoff profile Vᵢ^{β}(s, π) for each i induces the best response policy (as shown in Eq. (12)) played by SP i in the CurRA game. Hence, the policy of SP i to play the whole stochastic game can be interpreted as (πᵢ^{CurRA}(s,π)π).

However, it is difficult to find the Nash equilibrium π* in the FutRA game. Even if the discounted average utility Vᵢ^{β}(s,π*) at the Nash Equilibrium policy is known, SP i has to know the state transition pr (g₋ᵢ′|g₋ᵢ,r₋ᵢ(θᵢ,θ₋ᵢ,H)) of other SPs and the channel state distribution pr(H) of the NO, which is impossible to be known in practice. Instead of directly finding the Nash equilibrium π* in the FutRA game, those policies that lead to decoupling in the payoff function, i.e., Vᵢ^{β}(s,π)=Vᵢ^{β}(gᵢ,πᵢ), are beneficial. The benefits of this decoupling will be clear below.

The decoupling can be achieved by introducing a conjectural price λᵢ={λₖ}_{kεK}_{ᵢ} where λₖε□₊. Via the conjectural price λᵢ, SP i no longer requires any information about other SPs and the NO, e.g., states, state transitions, etc. The conjectural price is defined as follows.

Definition 3: Conjectural Price

The conjectural price λᵢ is the belief of SP i on the per unit cost (charged by the NO) on the allocated rate (by the NO) in the FutRA game.

The conjectural price λᵢ represents the potential congestion level SP i believes in the future. It is noted that the conjectural price is not the true (average) price that SP i will be charged in the FutRA game. It may be very different from the true price. However, the conjectural price allows the SP to envision the possible congestion it will experience without knowing other SPs and NO's private information and Vᵢ^{β}(s,π).

### Lemma 4: Conjectural State Value Function

Given the conjectural price, i, the FutRA game is decomposed into M independent Markov decision processes each of which corresponds to the rate allocation for one SP and the discounted average utility (called “Conjectural State Value Function”) of SP i starting from the traffic state g, in the FutRA game is independently computed as

$${V}_{i}^{β , cp} ( {g}_{i} , {λ}_{i} ) = {\sum }_{k ∈ {𝒦}_{i}} {U}_{k}^{β , cp} ( {g}_{k} , {λ}_{k} ) \qquad ( 13 )$$

where Uₖ^{β,cp}(gₖ,λₖ) is the solution to the following Bellman's equations

$${U}_{k}^{β , cp} ( {g}_{k} , {λ}_{k} ) {max}_{{r}_{k} ∈ {ℝ}_{+}} \{ \{ \begin{matrix}( 1 - β ) ( {α}_{k} {u}_{k} ( {g}_{k} , {r}_{k} ) - {λ}_{k} {r}_{k} ) + \\ β {\sum }_{{g}_{k}^{′}} pr ( {g}_{k}^{′} \vert {g}_{k} , {r}_{k} ) {U}_{k}^{β , cp} ( {g}_{k}^{′} , {λ}_{k} )\end{matrix} \} \} , ∀ {g}_{k} \qquad ( 14 )$$

Proof: Given the conjectural price λᵢ, instead of competing for the rate, SP i selects the optimal transmission rates that maximize the discounted average utility (i.e. conjectural state value function) starting from the traffic state gᵢ in the FutRA game. In this case, the conjectural state value function is expressed as

$$\begin{matrix}{V}_{i}^{β , cp} ( {g}_{i} , {λ}_{i} ) = {max}_{{r}_{i}^{t} , t > 0} \{ ( 1 - β ) {\sum }_{t = 1}^{∞} {β}^{t - 1} \{ {\sum }_{k ∈ {𝒦}_{i}} {α}_{k} {u}_{k} ( {g}_{k}^{t} , {r}_{k}^{t} ) - {λ}_{k} {r}_{k}^{t} \} \} \\ = {\sum }_{k ∈ {𝒦}_{i}} {max}_{{r}_{k}^{t} , t > 0} \{ ( 1 - β ) {\sum }_{t = 1}^{∞} {β}^{t - 1} \{ {α}_{k} {u}_{k} ( {g}_{k}^{t} , {r}_{k}^{t} ) - {λ}_{k} {r}_{k}^{t} \} \} \\ = {\sum }_{k ∈ {𝒦}_{i}} {U}_{k}^{β , cp} ( {g}_{k} , {λ}_{k} )\end{matrix} \qquad ( 15 )$$

It is clear that the computation of Vᵢ^{β,cp}(gᵢ,λᵢ) is decomposed into |Kᵢ| sub-problems each of which is to compute the payoff for user k. Each sub-problem can be formulated as a MDP problem having the Bellman's equation as shown in (14).

Lemma 4 indicates that, given the conjectural price λᵢ, SP i is able to compute the conjectural state value function which serves as the an approximated version of the discounted average payoff of SP i achieved at the Nash equilibrium policy π*. The approximation enables us to simplify the best response given in Eq. (12) at the CurRA game as follows.

$${θ}_{i} ( s , {θ}_{- i} , {λ}_{i} ) = arg {max}_{{θ}_{i} ∈ {Θ}_{i}} \{ \begin{matrix}( 1 - β ) ( {\sum }_{k ∈ {𝒦}_{i}} {α}_{k} {u}_{k} ( {g}_{k} , {r}_{k} ( {θ}_{i} , {θ}_{- i} , H ) ) + {τ}_{i} ( {θ}_{i} , {θ}_{- i} , H ) ) + \\ β {\sum }_{k ∈ {𝒦}_{i}} {\sum }_{{g}_{k}^{′}} \{ pr ( {g}_{k}^{′} \vert {g}_{k} , {r}_{k} ( {θ}_{i} , {θ}_{- i} , H ) ) {U}_{k}^{β , cp} ( {g}_{k}^{′} , {λ}_{k} ) \}\end{matrix} \} \qquad ( 16 )$$

In this approximation, the states of other SPs and the channel states from next time slot on are ignored.

Below the role of the conjectural price in the context of the stochastic game is further explained. After introducing the conjectural price, the SPs independently select their own conjectural prices λᵢ, ∀ᵢ in the FutRA game and the output is Vᵢ^{β,cp}(gᵢ′, λᵢ), ∀i. Hence, the policy of SP i to play this stochastic game becomes (πᵢ^{CurRA}(s,λᵢ),λᵢ) instead of (πᵢ^{CurRA}(s,π),π), as shown in FIG. 3. The difference is that, using the conjectural price, the payoff in the FutRA game is decomposed which significantly simplifies the selection of the value function 9, in playing the CurRA game.

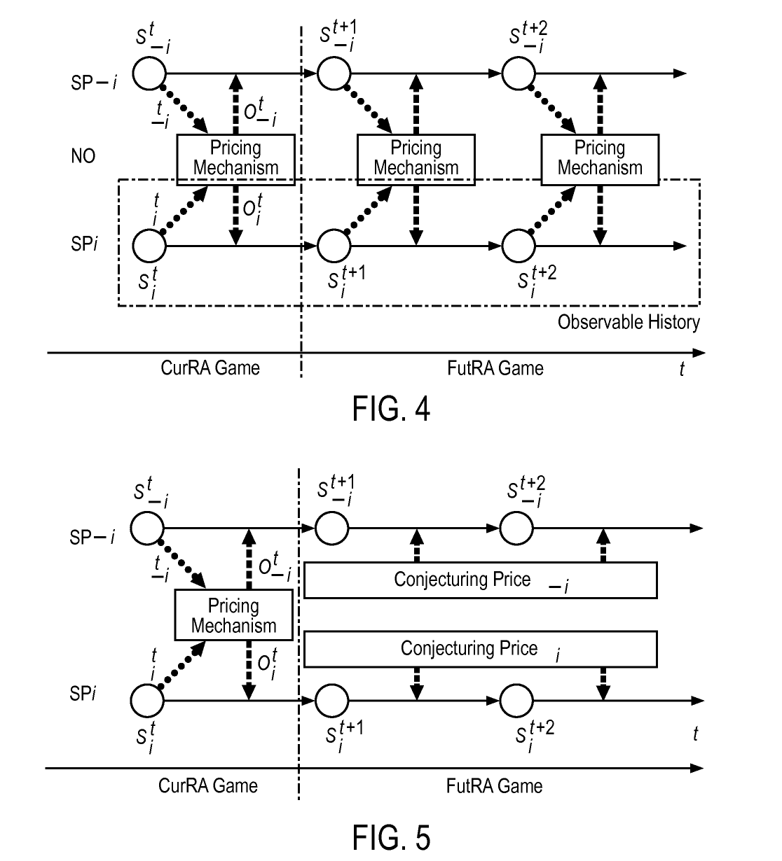

FIG. 4 depicts the resource allocation game inter-played by different SPs and the NO. The bidding actions taken at time t by SP i impacts the resource allocation decisions o^{t} of the NO at that time. From SP i perspective, it only sees the rates allocated to its users and the price tag which corresponds to oᵢ^{t}. However SP i's bid θᵢ^{t}=θᵢ(gᵢ^{t},rᵢ^{t}) impacts the rates allocated to other SPs' users and their corresponding price tags which is denoted by o₋ᵢ^{t}. Due to this coupling, it is hard for an individual SP to optimize its own bidding decisions. This brings us to the solution drawn in FIG. 5. In one embodiment, the NO assists individual SPs in their optimization problems by supplying conjectured prices for each SP to reflect the current best guess of the network about the future congestion and associated pricing. The conjecturing of future prices by the NO is updated as the states and expectations about the future congestion change over time. By appropriately setting the conjectured price, the NO can drive the resource utilization to an efficient point while letting individual SPs to adapt to the changes.

Below, the focus is on the value function computation when the conjectural prices are given, including the conjectural price selection process.

C. Repeated CurRA Game with Fixed Conjectural Prices

Below, the focus is on the CurRA game when the conjectural prices of all the SPs are fixed. As discussed in above, the resource allocation in the CurRA game is performed through the VCG mechanism. Rearranging Eq. (16), the following is obtained

$${θ}_{i} ( s , {θ}_{- i} , {λ}_{i} ) = arg {max}_{{θ}_{i} ∈ {Θ}_{i}} ( 1 - β ) \cdot \{ \begin{matrix}{\sum }_{k ∈ {𝒦}_{i}} \{ \begin{matrix}{α}_{k} {u}_{k} ( {g}_{k} , {r}_{k} ( {θ}_{i} , {θ}_{- i} , H ) ) + \frac{β}{( 1 - β )} \\ {\sum }_{{g}_{k}^{′}} \{ pr ( {g}_{k}^{′} \vert {g}_{k} , {r}_{k} ( {θ}_{i} , {θ}_{- i} , H ) ) {U}_{k}^{β , cp} ( {g}_{k}^{′} , {λ}_{k} ) \}\end{matrix} \} + \\ {τ}_{i} ( {θ}_{i} , {θ}_{- i} , H ) .\end{matrix} \} \qquad ( 17 )$$

Compared to the payoff in the VCG mechanism, the truthful value function of SP i in the CurRA game is defined as:

$$\begin{matrix}{θ}_{i} ( {g}_{i} , {r}_{i} ) = {\sum }_{k ∈ {𝒦}_{i}} {α}_{k} {u}_{k} ( {g}_{k} , {r}_{k} ) + \\ \frac{β}{( 1 - β )} {\sum }_{{g}_{k}^{′}} \{ pr ( {g}_{k}^{′} \vert {g}_{k} , {r}_{k} ) {U}_{k}^{β , cp} ( {g}_{k}^{′} , {λ}_{k} ) \} \\ = {\sum }_{k ∈ {𝒦}_{i}} {θ}_{k} ( {g}_{k} , {r}_{k} )\end{matrix} \qquad ( 18 )$$

In this value function, SP i not only cares about its immediate utility but also the future payoff through the state transition. The payoff of SP i in the VCG mechanism is (1−β)(θᵢ(gᵢ,rᵢ)+τᵢ). From above, the payoff in the FutRA game affects the action selection in the CurRA game through the best response as shown in Eq. (12). Note that the coupling in the payoff from the general policies played in the FutRA game prohibits the computation of the best response in the CurRA game. However, this coupling is decomposed by introducing the conjectural prices. Given the conjectural prices λᵢ, ∀i, the SPs have the fixed value function θᵢ(gᵢ,rᵢ) in the CurRA game. Then, the CurRA game becomes one-shot game induced by the VCG mechanism. In this one shot game, there exists one dominant strategy which is incentive-compatible and truth-revealing. However, note that the incentive-compatible and truth-revealing strategy is with respect to the conjectural prices. This dominant strategy is denoted by θᵢ*(gᵢ,λᵢ). Going back to the stochastic rate allocation game, the selection of the conjectural price is analogical to the policy for playing the FutRA game. Once the conjectural prices are fixed, the curRA game is played independently of the FutRA game. Hence, the stochastic game is simplified into a repeated curRA game. In this repeated curRA game, the dominant strategy is described as follows.

Proposition 5: Dominant Strategy in the Repeated CurRA Game with Fixed Conjectural Price

In the stochastic game, if the SPs are restricted to select the policy (θᵢ,λᵢ), ∀ᵢ, then for any conjectural price profile λᵢ, ∀ᵢ, (θᵢ*(gᵢ, λᵢ), λᵢ), ∀ᵢ is a dominant strategy profile.

Proof: Given the conjectural prices λᵢ, ∀ᵢ, each CurRA game with any state s is a one shot resource allocation game induced by the VCG mechanism, and (θᵢ*(gᵢλᵢ),λᵢ) is the dominant strategy in this game as discussed above. Hence, it is also the dominant strategy in the repeated CurRA game with the fixed conjectural prices.

Proposition 5 implies that there are infinite number of dominant strategies in the repeated CurRA game since any conjectural price profile induces one dominant equilibrium, similar to the Folk theorem in the repeated game. The remaining problem is how to select an appropriate conjectural price profile to play the FutRA game.

### Conjectural Price Selection

In one embodiment, the selection of the conjectural prices to play the FutRA game is performed such that the SPs maximize their own payoffs. Since within the disclosed virtualization framework, SPs only observe a partial history

Hᵢ^{t}={gᵢ¹,θᵢ¹,rᵢ¹,τᵢ¹, . . . , gᵢ^{t-1},θᵢ^{t-1},rᵢ^{t-1},τᵢ^{t-1},gᵢ^{t}} it is often difficult to infer the congestion level (e.g., conjectural price) for the FutRA game from this partially observed history. However, the NO collects all the value functions (which represents the utility of the SPs) and then makes the rate allocation and payment computation. In other words, the NO has the global information about the whole network and it is in a perfect position to advertise conjectural prices to SPs to guide their bidding decisions.

Two issues are what conjectural prices should the NO advertise and whether the SPs adopt these prices as their own conjectural prices or not. First look at the best performance (i.e., highest system utility) the NO can obtain using the conjectural prices in the cooperative and decentralized scenarios, and then analyze whether the conjectural prices corresponding to the best performance can be adopted by the SPs.

### Cooperative Solution Using Conjectural Prices

From the perspective of the NO, the efficient resource allocation is to cooperatively maximize the sum utility of all wireless users as given by

$${U}^{coop} ( {s}^{t} ) = {max}_{{r}^{{t}^{′}} ∈ {ℛ}^{{t}^{′}} , ∀ {t}^{′} \geq t} ( 1 - β ) {\sum }_{{t}^{′} = t}^{∞} {β}^{{t}^{′} - t} {\sum }_{k = 1}^{K} {α}_{k} {u}_{k} ( {g}_{k}^{{t}^{′}} , {r}_{k}^{{t}^{′}} )$$

Based on the conjectural price profile λ, the rate constraint r^{t}εR^{t} is relaxed by introducing the cost of violating rate constraint at time slot t, i.e. AT (r^{t}−\hat{r}^{t}(λ)) where \hat{r}^{t}(λ) is the optimal rate within the feasible rate region to the following optimization problem:

$${\hat{r}}^{t} ( λ ) = arg { max}_{r ∈ {ℛ}^{t}} {λ}^{T} r \qquad ( 19 )$$

Note that the relaxation is a generalized Lagrangian relaxation for the convex constraint, e.g. r^{t}εR^{t} herein. For example, for the rate constraint r≦C and the price (Lagrangian multiplier) λ≧0, the cost of violating the rate constraint is given by λ^{T}(r−C) where C=arg maxr·C=arg max_{r≦Cλ}_{^{T}}ᵣ.

Then, the following:

$${U}^{coop} ( {s}^{t} , λ ) = {max}_{{r}_{k}^{{t}^{′}} ∈ {ℝ}_{+}^{K} , {t}^{′} \geq t} ( 1 - β ) \cdot {\sum }_{{t}^{′} = t}^{∞} {β}^{{t}^{′} - t} \{ {\sum }_{k = 1}^{K} {α}_{k} {u}_{k} ( {g}_{k}^{{t}^{′}} , {r}_{k}^{{t}^{′}} ) - {λ}^{T} ( {r}^{{t}^{′}} - {\hat{r}}^{{t}^{′}} ( λ ) ) \} = {\sum }_{k = 1}^{K} {max}_{{r}_{k}^{{t}^{′}} ∈ {ℝ}_{+} , {t}^{′} \geq t} ( 1 - β ) {\sum }_{{t}^{′} = t}^{∞} {β}^{{t}^{′} - t} \{ {α}_{k} {u}_{k} ( {g}_{k}^{{t}^{′}} , {r}_{k}^{{t}^{′}} ) - {λ}_{k} {r}_{k}^{{t}^{′}} \} + ( 1 - β ) {λ}^{T} {\sum }_{{t}^{′} = t}^{∞} {β}^{{t}^{′} - t} {\hat{r}}^{{t}^{′}} ( λ ) = {\sum }_{k = 1}^{K} {U}_{k}^{coop} ( {g}_{k}^{t} , {λ}_{k} ) + ( 1 - β ) {λ}^{T} {\sum }_{{t}^{′} = t}^{∞} {β}^{{t}^{′} - t} {\hat{r}}^{{t}^{′}} ( λ ) \qquad ( 20 )$$

Note that \hat{r}^{t}(λ) is determined based on the conjectural price λ and the rate region Rt (and hence, the channel condition Ht) and is independent of the selection of the rate R^{t}. Note also that Uₖ^{coop}(gₖ^{t}, λₖ)=Uₖ^{β,cp}(gₖ^{t},λₖ) as shown in Lemma 4 and they can be computed by the corresponding SPs. Hence, Uₖ^{coop}(s^{t},λ) is essentially composed of two terms which can be computed independently by the SPs (computing the first term) and the NO (computing the second term) using their own state transitions given λ and then combined together.

Note also Uₖ^{coop}(s^{t},λ)≧Uₖ^{coop}(s^{t}),∀s^{t}. In other words, Uₖ^{coop}(s^{t},λ) is the upper bound of Uₖ^{coop}(s^{t}) for any state s^{t}. Using Uₖ^{coop}(s^{t},λ) as the approximated state-value function for the cooperative rate allocation, an optimal feasible rate allocation r^{λ}(s^{t})εR^{t} with respect to Uₖ^{coop}(s^{t},λ) can be found, which is the solution to the following optimization problem.

$${U}^{coop , λ} ( {s}^{t} ) = {max}_{{r}^{t} ∈ {•}^{t}} \{ ( 1 - β ) {\sum }_{k = 1}^{K} α {u}_{k} ( {g}_{k}^{t} , {r}_{k}^{t} ) + β {\sum }_{{s}^{t + 1}} pr ( {s}^{t + 1} \vert {s}^{t} , {r}^{t} ) {U}^{coop} ( {s}^{t} , λ ) \} = ( 1 - β ) {max}_{{r}^{t} ∈ {R}^{t}} {\sum }_{k = 1}^{K} \{ \begin{matrix}α {u}_{k} ( {g}_{k}^{t} , r {\leq }_{k}^{t} ) + \\ \frac{β}{1 - β} {\sum }_{{g}_{k}^{t + 1}} pr ( {g}_{k}^{t + 1} \vert {g}_{k}^{t} , {t}_{k}^{t} ) {U}_{k}^{coop} ( {g}_{k}^{t} , {λ}_{k} )\end{matrix} \} + ( 1 - β ) {λ}^{T} {\sum }_{{t}^{′} = t}^{∞} {β}^{{t}^{′} - t} {\hat{r}}^{{t}^{′}} ( λ ) = {\sum }_{k = 1}^{K} {U}_{k}^{coop} ( {g}_{k}^{t} , {λ}_{k} ) + ( 1 - β ) {λ}^{T} {\sum }_{{t}^{′} = t}^{∞} {β}^{{t}^{′} - t} {\hat{r}}^{{t}^{′}} ( λ ) \qquad ( 21 )$$

where R(λ)=(1−β)^{λ}^{^{T}}Σ_{t′=t}^{∞}β^{t′-t}\hat{r}^{t′}(λ) is computed by the NO and independent of the rate selection. From the monotonicity of the dynamic programming, note that Uₖ^{coop}(s^{t},λ)≧Uₖ^{coop}(s^{t})≧Uₖ^{coop}(s^{t}),∀s^{t}. Then the best conjectural price can be selected to minimize the gap between U^{coop,λ}(s^{t}) and U^{coop}(s^{t}), i.e.

$$r {λ}^{*} = arg {max}_{λ \geq 0} {\sum }_{s} μ ( s ) {U}^{coop , λ} ( s ) . \qquad ( 22 )$$

where μ(s) is the stationary distribution of the network state. Hence, the best conjectural price generates the feasible rate allocation policy as shown in Eq. (21) which provides the optimal cooperative utility U^{coop,λ*}(s). The best conjectural price profile λ* as the efficient price profile for purposes here, since it provides the efficient rate allocation in this distributed solution. Hence, the NO would like all the SPs to adopt this efficient price profile. With truthfully revealing the value functions by the SPs, the NO is able to allocate the network resources efficiently.

### Nash Equilibrium of Efficient Price

It is possible that the efficient price profile is not the preferable price for the SPs. From above, λ* provides the best cooperative utility, i.e. it gives the efficient resource allocation. To enforce the SPs to adopt the conjectural prices advertised by the NO, the rate allocation is first computed based on the advertised prices, which is given as follows.

$$r ( s , {λ}^{*} ) = arg {max}_{r \geq 0} {\sum }_{k = 1}^{K} {θ}_{k} ( {g}_{k} , {r}_{k} ) - {( {λ}^{*} )}^{T} r \qquad ( 23 )$$

This rate can be computed by the NO since θₖ(gₖrₖ),∀k are revealed by the SPs. Then, the following theorem shows that λ* is the Nash equilibrium of the stochastic game played by the SPs as shown above.

### Theorem 6: Nash Equilibrium of Conjectural Price

λ* results in the efficient rate allocation in the CurRA game and is the Nash equilibrium of the FutRA game in the stochastic game when the additional payments A{(1−β)(λ*)^{T}Σₜ₌₁^{∞}β^{t-1}r(s^{t},λ*)}⁺ are charged to each SP, where A≧0 is large enough.

Proof: From Proposition 5, given λ*, the SPs truthfully declare their value function which is θᵢ(gᵢrᵢ)=Σ_{kεK}_{ᵢ}θₖ(gₖ,rₖ)) as shown in Eq. (18). After receiving the value functions from the SPs, the NO performs the rate allocation as follows.

$${r}^{*} ( s ) = arg {max}_{r ∈ R ( H )} {\sum }_{k = 1}^{K} {θ}_{k} ( {g}_{k} , {r}_{k} ) = arg {max}_{r ∈ R ( H )} {\sum }_{k = 1}^{K} \{ \{ {}_{\frac{β}{1 - β}} {\sum }_{{g}_{k}^{′}} \begin{matrix}{α}_{k} {u}_{k} ( {g}_{k} , {r}_{k} ) + \\ \{ pr ( {g}_{k}^{′} \vert {g}_{k} , {r}_{k} ) {U}_{k}^{β , cp} ( {g}_{k}^{′} , {λ}_{k} ) \}\end{matrix} \} \} \qquad ( 24 )$$

where θₖ (gₖrₖ) is given as in Eq. (18). Since Uₖ^{coop}(gₖ^{t},πₖ*)=Uₖ^{β,cp}(gₖ^{t},λₖ*). The above optimization is equivalent to the optimization in Eq. (21). In other words, λ* gives the efficient rate allocation in the CurRA game.

Since uₖ(gₖ; rₖ) is a differential and concave function of rₖ, it can be shown θₖ(gₖrₖ) is also a concave function for any conjectural price λₖ. Since λ* is the efficient conjectural price, it can be shown that (1−β)(λ*)^{T}Σₜ₌₁^{∞}β^{t-1}r(s^{t},λ*)−R(λ*)≦0 when the SPs reveal their value functions computed with the conjectural prices λ*, which means the rate allocation satisfies the long-term constraint. When the SPs announce the value functions with other conjectural prices λ≠λ* which is not the solution to Eq. (22), the following exists (1−β)(λ*)^{T}Σₜ₌₁^{∞}β^{t-1}r(s^{t},λ*)−R(λ*)≧0. When A is large enough, the SPs do not have any incentive to select the conjectural prices other than λ*.

From Theorem 6, it is clear that when the SPs are enforced to take the conjectural prices to play the FutRA game, one Nash Equilibrium is the efficient price λ*. Furthermore, given the Nash equilibrium, the SPs play the CurRA game by truthfully revealing the value function which results in the efficient rate allocation. This truthful revelation actually leads to the dominant equilibrium in the CurRA game.

Thus, a virtualization framework for wireless networks to support multiple heterogeneous self-interested services has been described. Such virtualization enables us to separate the service providers (SP) from the network operator (NO) and let each focus on their fundamental functions. The proposed framework approaches this separation problem as a stochastic game where self-interested SPs compete for the network resources managed and priced by a single NO. Due to the difficulty in directly solving the stochastic game in a decentralized fashion, the conjectural price is introduced for the SPs to remove the inter-dependency among their future bids for the spectrum. In this set up, SPs select the conjectural price for playing the future game and announce the value function for playing the current game. It is proved that, given the conjectural price profile, SPs truthfully reveal the value function which is dominant equilibrium in the current game, and there exists one conjectural price profile that is Nash equilibrium and results in efficient resource allocation under the proposed separation between SPs and the NO.

There remains two main issues that are involved in designing a practical system and are part of the ongoing work:

(i) In the one time slot resource allocation, a VCG mechanism is employed that requires the SPs to reveal the entire value function. The value function is often difficult to be parameterized and needs significant amount of signaling to reveal. To combat this obstacle, the value function can be approximated by a piece-wise linear function which is compactly represented by a few parameters. As shown in Maille et al., “Multi-bid auctions for bandwidth allocation in communication networks”, Proc. of Infocom, Hong Kong, 7-11 Mar. 2004, this approximation can keep the properties of the VCG mechanism within a rang of ε which is the approximation error.

(ii) The existence of a Nash equilibrium conjectural price profile for the stochastic game has been proven. To compute this Nash equilibrium, the NO needs to know the distribution of the channel conditions and SPs need to know the transition probability of traffic states. Furthermore, the NO has to solve a complicated optimization shown in Eq. (22). To reduce the computation complexity, an iterative solution to update the conjectural price which converges to the efficient one can be used. This iteration does not require the NO to know the distribution of the channel conditions. The SPs are also allowed to learn the value function based on the past experiences, which does not need the knowledge of the traffic state transitions.

### An Example of a Computer System

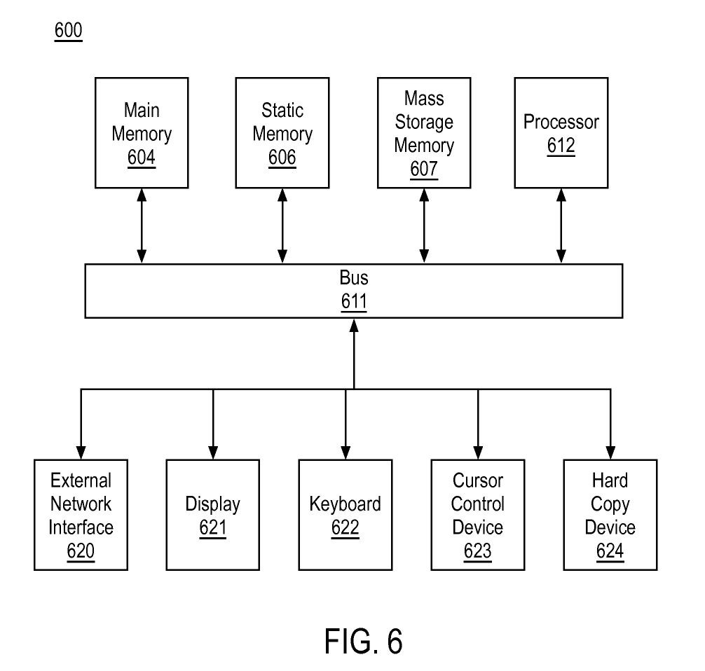

FIG. 6 is a block diagram of an exemplary computer system that may perform one or more of the operations described herein. Referring to FIG. 6, computer system 600 may comprise an exemplary client or server computer system. Computer system 600 comprises a communication mechanism or bus 611 for communicating information, and a processor 612 coupled with bus 611 for processing information. Processor 612 includes a microprocessor, but is not limited to a microprocessor, such as, for example, Pentium™, PowerPC™, Alpha™, etc.

System 600 further comprises a random access memory (RAM), or other dynamic storage device 604 (referred to as main memory) coupled to bus 611 for storing information and instructions to be executed by processor 612. Main memory 604 also may be used for storing temporary variables or other intermediate information during execution of instructions by processor 612.

Computer system 600 also comprises a read only memory (ROM) and/or other static storage device 606 coupled to bus 611 for storing static information and instructions for processor 612, and a data storage device 607, such as a magnetic disk or optical disk and its corresponding disk drive. Data storage device 607 is coupled to bus 611 for storing information and instructions.

Computer system 600 may further be coupled to a display device 621, such as a cathode ray tube (CRT) or liquid crystal display (LCD), coupled to bus 611 for displaying information to a computer user. An alphanumeric input device 622, including alphanumeric and other keys, may also be coupled to bus 611 for communicating information and command selections to processor 612. An additional user input device is cursor control 623, such as a mouse, trackball, trackpad, stylus, or cursor direction keys, coupled to bus 611 for communicating direction information and command selections to processor 612, and for controlling cursor movement on display 621.

Another device that may be coupled to bus 611 is hard copy device 624, which may be used for marking information on a medium such as paper, film, or similar types of media. Another device that may be coupled to bus 611 is a wired/wireless communication capability 625 to communication to a phone or handheld palm device.

Note that any or all of the components of system 600 and associated hardware may be used in the present invention. However, it can be appreciated that other configurations of the computer system may include some or all of the devices.

Whereas many alterations and modifications of the present invention will no doubt become apparent to a person of ordinary skill in the art after having read the foregoing description, it is to be understood that any particular embodiment shown and described by way of illustration is in no way intended to be considered limiting. Therefore, references to details of various embodiments are not intended to limit the scope of the claims which in themselves recite only those features regarded as essential to the invention.

We claim:

1. A wireless communication network comprising:
a plurality of service providers operable to bid on network resources on behalf of a plurality of individual receivers; and
a wireless network operator, communicably coupled to the plurality of service providers, to perform resource allocation using an auction to allocate network resources to the plurality of service providers based on instantaneous channel conditions and traffic information of each of said plurality of individual receivers and to schedule transmissions in time and space to a plurality of individual receivers.

2. The network defined in claim 1 wherein each service provider bids for the next scheduling interval by providing a value function.

3. The network defined in claim 2 wherein the value function is based on a rate vector corresponding to a user of the service provider.

4. The network defined in claim 2 wherein the network operator solves an optimization problem based on the bids receiver from different service providers.

5. The network defined in claim 2 wherein the network operator supplies conjectural prices for each service provider to reflect a current best guess of the network, the conjectural prices being based on received value functions.

6. The network defined in claim 1 wherein the network operator observes channel quality indicators and knows operational rate region constraints, the network operator advertising a conjectural price vector to the service providers, where the conjectural price reflects future pricing of the wireless resources.

7. The network defined in claim 6 wherein the network operator receives utility-rate functions from each service provider, optimizes a sum utility under the rate region constraints using the received utility rate functions, and prices resource allocation decisions using a mechanism.

8. The network defined in claim 7 wherein the mechanism comprises a Vickery-Clark-Grove mechanism.

9. The network defined in claim 1 wherein the network operator abstracts the channel conditions via a time-varying feasible rate region.

10. The network defined in claim 1 wherein the network operator is operable to receive value functions from the plurality of service providers and perform the resource allocation based on the received value functions.

11. The network defined in claim 10 wherein the value functions are rate-utility functions that are an abstract representation of the traffic information.

12. The network defined in claim 10 wherein the value functions are updated, at each frame, by the service providers at observed traffic states based on advertised conjectural prices.

13. The network defined in claim 12 wherein the network operator computes a stochastic sub-gradient based on the value functions, updates the conjectural price and advertises the updated conjectural price to the plurality of service providers.

14. The network defined in claim 1 wherein the network operator is agnostic to specific QoS objectives and constraints of individual services performed by the service providers.

15. The network defined in claim 1 wherein the service providers bid on behalf of their individual receivers for network resources to be allocated in a next scheduling interval, and the network operator specifies user scheduling and a spectrum allocation policy that determines rates received by each user in the next scheduling interval based on an achievable rate region and the bids submitted by one or more service providers.

16. The network defined in claim 1 wherein the network operator is operable to manage all physical layer and MAC layer stacks, including mapping individual user payloads on to radio carriers through channel coding, modulation, and waveform generation.

17. The network defined in claim 1 wherein each service provider manages and queues user payloads above the radio link layer.

18. The network defined in claim 1 wherein available wireless network resources are abstracted as a rate region, wherein the rate region is computed as a set of rate that can be achieved by a spectrum allocation under a current channel gain profile.

19. The network defined in claim 1 wherein the network operator is operable to compute an achievable rate region at a given block error rate.

20. The network defined in claim 1 wherein the network operator includes an agent to compute user utilities based on current queue state of each user, extra utility of additional payload served from the queue, available budget a service provider has, and the pricing enforced by the network operator.

21. The network defined in claim 1 wherein each service provider includes data plane functionality to manage queues for buffering data for each individual receiver being supported by said each service provider and control plane functionality to observe queue states and to perform a value function computation that determines an expected profit using a conjectural price received from the network operator.

22. The network defined in claim 21 wherein the network operator comprises a radio resource manager (RRM) that includes:
a resource abstract;
abstract resource allocation; and
a multi-user scheduler to perform multi-user scheduling based on known capacity or rates supported by users in the network.
